(19) United States
(12) Patent Application Publication
(10) Pub. No.: US 2023/0150174 A1
(43) Pub. Date: May 18, 2023

(54) ADJUSTABLE LOCATOR RETAINING WALL BLOCK AND MOLD APPARATUS

(71) Applicant: PAVESTONE, LLC, Atlanta, GA (US)

(72) Inventor: William H. Karau, Blanco, TX (US)

(73) Assignee: PAVESTONE, LLC, Atlanta, GA (US)

(21) Appl. No.: 18/096,990

(22) Filed: Jan. 13, 2023

Related U.S. Application Data
(63) Continuation of application No. 17/157,285, filed on Jan. 25, 2021, now Pat. No. 11,554,521.
Application No. 17/157,285 is a continuation of application No. 16/693,994, filed on Nov. 25, 2019, now Pat. No. 10,899,049.
Application No. 16/693,994 is a continuation of application No. 15/994,313, filed on May 31, 2018, now Pat. No. 10,486,344.
Application No. 15/994,313 is a continuation of application No. 15/688,784, filed on Aug. 28, 2017, now Pat. No. 9,999,993.
Application No. 15/688,784 is a continuation of application No. 15/074,830, filed on Mar. 18, 2016, now Pat. No. 9,744,697.
Application No. 15/074,830 is a continuation of application No. 14/311,194, filed on Jun. 20, 2014, now abandoned.
(60) Provisional application No. 61/838,205, filed on Jun. 21, 2013.

(51) Int. Cl. B29C 41/36; E02D 29/02; B28B 7/00; B28B 7/18; E04B 2/32; E04C 1/39; E04C 1/00

(52) U.S. Cl. CPC B29C 41/36; E02D 29/0266; B28B 7/00; B28B 7/0097; B28B 7/183; E04B 2/32; E04C 1/395; E02D 29/02; E02D 29/025; E04C 1/00; E04B 2002/0208

(57) ABSTRACT

A system of retaining wall blocks, a method of assembling a retaining wall block assembly, and a mold for manufacturing retaining wall blocks having adjustable engagement configurations.

### RELATED APPLICATIONS

The present application is a continuation of U.S. patent application Ser. No. 14/311,194, filed Jun. 20, 2014, which claims priority to U.S. Provisional Patent Application No. 61/838,205, filed on Jun. 21, 2013, which is hereby incorporated by reference for all purposes as if set forth herein in its entirety.

### TECHNICAL FIELD

The present disclosure relates to retaining wall blocks, and more specifically to a retaining wall having adjustable positioning engagements and a mold for manufacturing such.

### BACKGROUND OF THE INVENTION

Retaining wall blocks can be manufactured and arranged in a variety of different ways.

### SUMMARY OF THE INVENTION

A system of retaining wall blocks, a method of assembling a retaining wall block assembly, and a mold for manufacturing retaining wall blocks having adjustable engagement configurations.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIGS. 1A through 1C are diagrams of a retaining wall block in accordance with in accordance with an exemplary embodiment of the present disclosure;

FIGS. 2A through 2C are diagrams of retaining wall blocks in accordance with in accordance with an exemplary embodiment of the present disclosure;

FIGS. 3A through 3B are diagrams of retaining wall blocks in accordance with in accordance with an exemplary embodiment of the present disclosure;

FIGS. 4A through 4B are diagrams of a mold shoe in accordance with an exemplary embodiment of the present disclosure;

FIG. 5 is a diagram of a mold shoe in accordance with an exemplary embodiment of the present disclosure; and

FIG. 6 is a flow chart of a method for manufacturing a retaining wall with an adjustable incline angle, in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

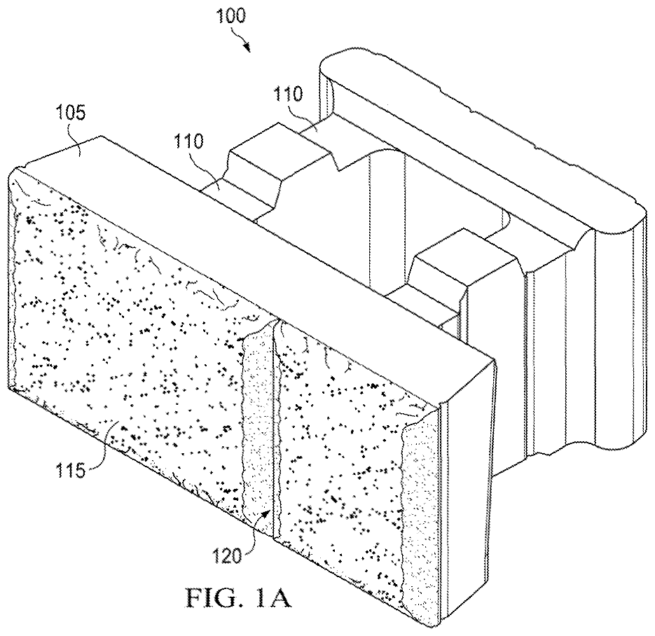

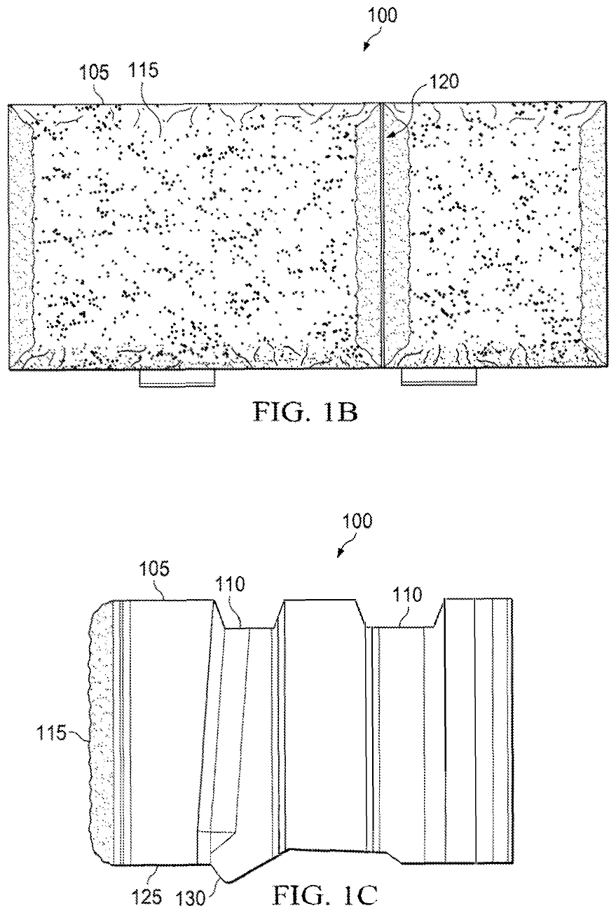

FIGS. 1A through 1C are diagrams of a retaining wall block 100 in accordance with an exemplary embodiment of the present disclosure. Retaining wall block 100 can be formed from masonry, concrete or other suitable materials, using a wet cast process, a dry cast process or other suitable processes. As shown in FIG. 1A, retaining wall block 100 includes a top face 105, engagement cavity 110, and textured front face 115. Textured front face 115 can be formed by splitting retaining wall block 100 from a second retaining wall block 100, as discussed in greater detail below. As shown in FIG. 1B, which is a front view of retaining wall block 100, front face 115 includes a false joint 120 for aesthetic purposes.

As shown in FIG. 1C, which is a side view of retaining wall block 100, retaining wall block 100 further includes bottom surface 125 having at least one engagement protrusion 130. Engagement protrusion 130 is configured to interface with engagement cavity 110 of an underlying retaining wall block 100. Furthermore, the front engagement cavity 110 is offset from the location of engagement protrusion 130, so as to result in a staggered incline as successive rows of retaining wall blocks 100 are formed. In one embodiment of the present disclosure, the incline of successive rows of retaining wall blocks 100 is generally vertical with no staggering.

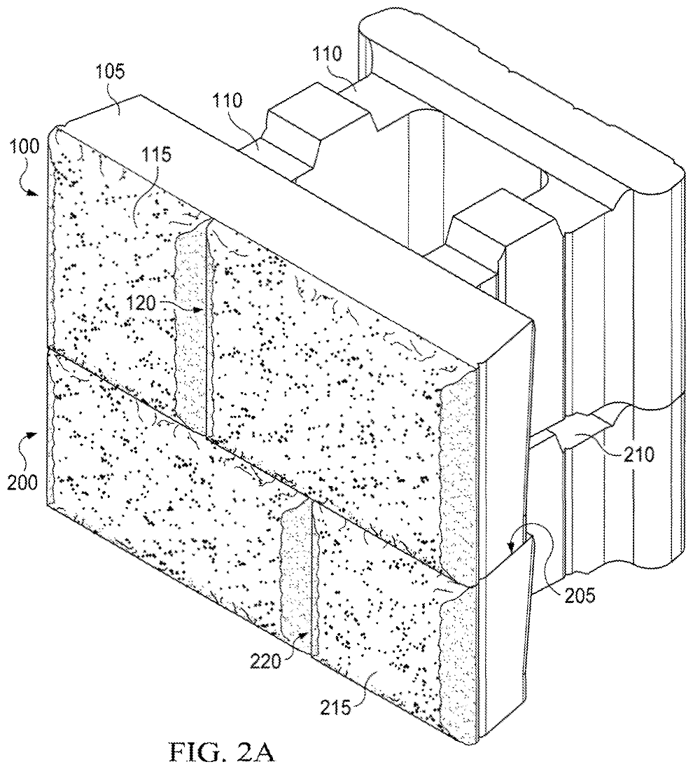

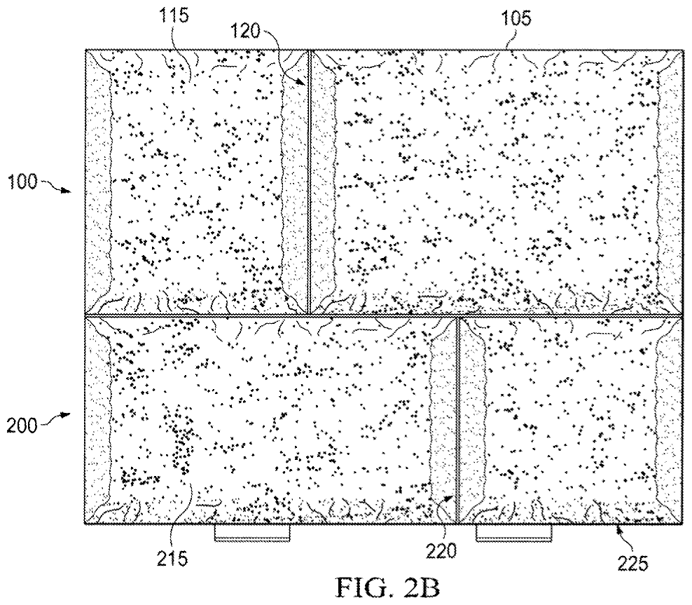

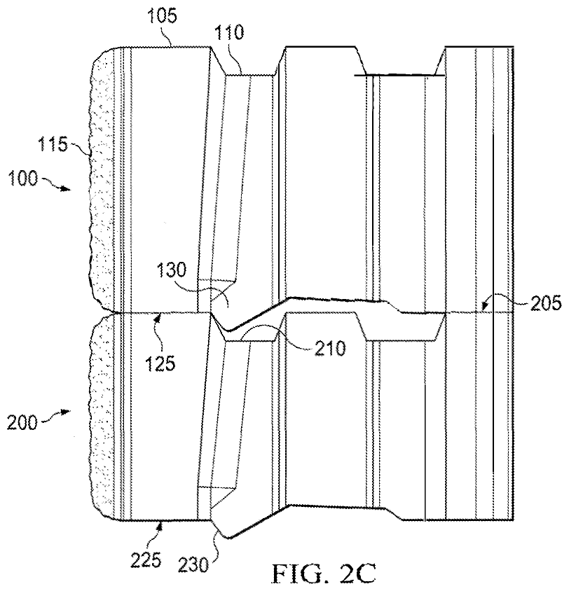

FIGS. 2A through 2C are diagrams of two engaged retaining wall blocks 100 and 200, in accordance with an exemplary embodiment of the present disclosure. As shown in FIG. 2A, retaining wall blocks 100 and 200 include top faces 105 and 205, respectively, engagement cavities 110 and 210, respectively, and textured front faces 115 and 215, respectively. As previously discussed, retaining wall blocks 100 and 200 can also have false joints 120 and 220, respectively, for aesthetic purposes, as shown in FIG. 2B. Likewise, other suitable false joints can also or alternatively be used.

In one embodiment of the present disclosure, first retaining wall block 100 is disposed onto a top surface 205 of a second retaining wall block 200. As shown in FIG. 2C, first retaining wall block 100 can positioned so that engagement protrusions 130 align with and fit into engagement cavity 210 of second retaining wall block 200.

In one embodiment of the present disclosure, the angle and configuration of engagement notches 110 and 210 and engagement members 130 and 230 can be varied to allow the blocks 100, 200 to be assembled with an offset. In one exemplary embodiment of the present disclosure, the angle of engagement notches 110 and 210 can be between about 30 degrees and about 90 degrees. Likewise, the angle of engagement members 130 and 230 can be between about 30 degrees and about 90 degrees.

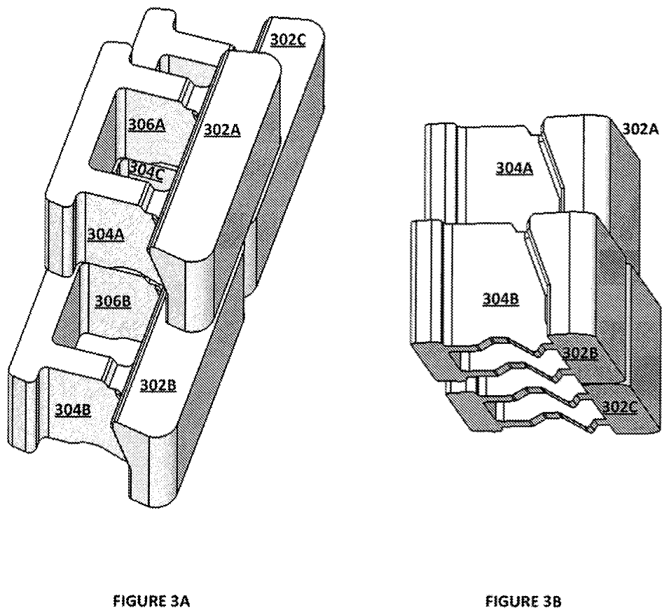

FIGS. 3A and 3B are diagrams of retaining wall blocks 302A, 302B and 302C, in accordance with an exemplary embodiment of the present disclosure. FIG. 3A shows an overhead view of retaining wall blocks 302A, 302B and 302C, with block 302A centered over blocks 302B and 302C. In addition, internal support 304A of block 302A is aligned with internal support 306B of block 302B, and internal support 306A of block 302A is aligned with internal support 304C of block 302C.

FIG. 3B shows an underside view of retaining wall blocks 302A, 302B and 302C. As can be seen, the blocks are H-shaped, and each include engagement cavities on a top surface and engagement protrusions on a bottom surface that can interlock with the engagement cavities at the top of underlying blocks. The location of the engagement cavities and engagement protrusions is adjustable, as previously described, so as to allow the angle of incline for the wall to be selected.

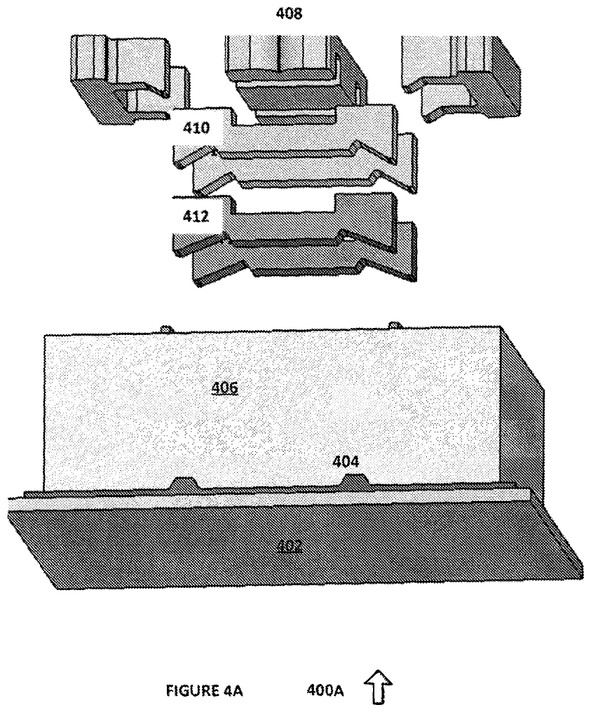

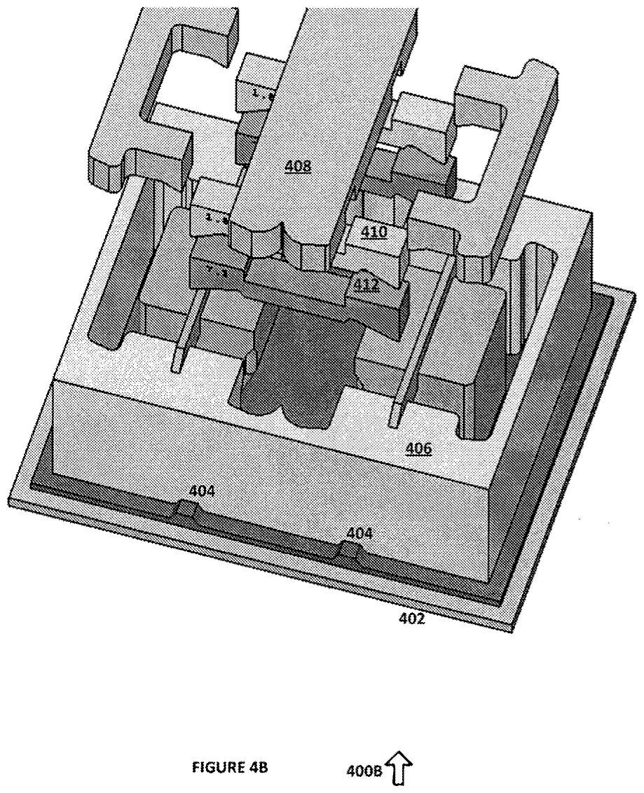

FIG. 4A through 4B are diagrams 400A and 400B of a mold for manufacturing retaining wall blocks, in accordance with an exemplary embodiment of the present disclosure. The mold can be formed from steel or other suitable materials, and can be configured to handle masonry, cement or other suitable materials.

As shown in FIGS. 4A through 4B, the mold includes a base portion 402 having a ridge 404, which is used to form the notch at the top of the block. The body 406 of the mold is placed on top of the base portion, and a shoe 408 with adjustable inserts 410 and 412 are provided that can be used to create blocks with different angles of incline, such as to allow a wall designer to specify an angle of incline. Inserts 410 and 412 interlock with shoe 408, such as by using a mechanical interlock device, screws or in other suitable manners.

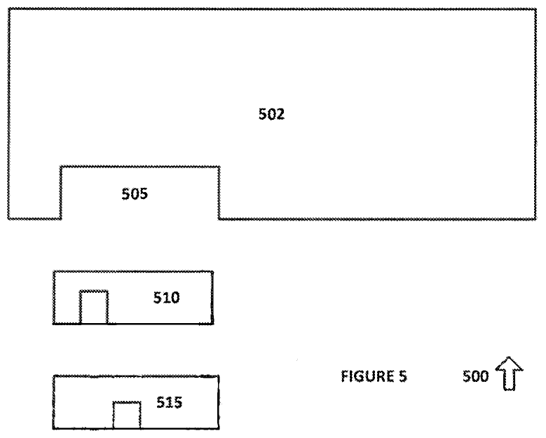

FIG. 5 is a diagram of a mold shoe 500 in accordance with an exemplary embodiment of the present disclosure. Mold shoe 500 includes body 502 and insert channel 505 that can be used to change the location of the at least one engagement protrusion. For example, by using insert A 510, the location of the at least one engagement protrusion is farther back than when using insert B 515. The location of the at least one engagement protrusion defines the incline of the wall, such as to allow the incline to be adjusted based on design specifications.

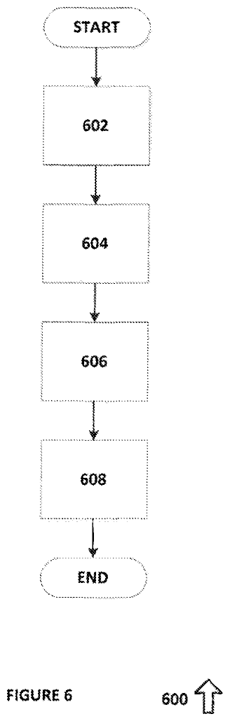

FIG. 6 is a flow chart of a method for manufacturing a retaining wall with an adjustable incline angle, in accordance with an exemplary embodiment of the present disclosure. Method 600 begins at 602, where an inset associated with a selected angle of incline is selected and incorporated into a mold. In one exemplary embodiment, the inset can be configured to interlock with a shoe of a mold assembly, such as by using a mechanical interlock, can be secured using screws or can otherwise be attached to the mold assembly. The method then proceeds to 604.

At 604, the mold is filled with masonry, cement or other suitable materials.

At 606, the shoe is used to compress the material into the mold and the shoe and mold is then removed.

At 608, the material is allowed to harden.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

1-5. (canceled)

6. A mold for a concrete block, comprising:
a base formed from a metallic material, the base having a ridge configured to form a notch at a top of a cast block;
a body formed from a metallic material and configured to be placed on top of the base; and
a shoe formed from a metallic material and configured to receive one or more adjustable inserts.

7. The mold of claim 6 wherein the one or more adjustable inserts are configured to interlock with the shoe.

8. The mold of claim 6 wherein the one or more adjustable inserts are configured to interlock with the shoe using a mechanical interlock device.

9. The mold of claim 6 wherein the one or more adjustable inserts are configured to interlock with the shoe using one or more screws.

10. The mold of claim 6 wherein the body is configured to receive one or more adjustable inserts.

11. The mold of claim 6 wherein the body is configured to receive one or more adjustable inserts that are each configured to interface with an associated ridge.

12. The mold of claim 6 wherein the body is configured to receive one of a first insert or second insert.

13. The mold of claim 6 wherein the body is configured to receive one of a first insert that is configured to interface with a first ridge or second insert that is configured to interface with a second ridge.

14. The mold of claim 13 wherein the first ridge is in a different location from the second ridge.

15. The mold of claim 6 wherein each of the adjustable inserts is associated with an angle of incline.

16. The mold of claim 6 wherein a first adjustable insert is associated with a first angle of incline.

17. The mold of claim 6 wherein a first adjustable insert is associated with a first angle of incline and a second adjustable insert is associated with a second angle of incline.

18. The mold of claim 6 wherein a first adjustable insert is associated with a first angle of incline and a second adjustable insert is associated with a second angle of incline that is different from the first angle of incline.

19. A method of using a mold for a concrete block, comprising:
placing a base formed from a metallic material on surface, the base having a ridge configured to form a notch at a top of a cast block;
placing a body formed from a metallic material on top of the base; and
placing a shoe formed from a metallic material and configured to receive one or more adjustable inserts in the body.

20. The method of claim 19 further comprising interlocking one or more adjustable inserts with the shoe.

21. The method of claim 19 further comprising interlocking one or more adjustable inserts with the shoe using a mechanical interlock device.

22. The method of claim 19 further comprising interlocking one or more adjustable inserts with the shoe using one or more screws.

23. The method of claim 19 further comprising placing one or more adjustable inserts in the body.

24. The method of claim 19 wherein each of the adjustable inserts is associated with an angle of incline.

25. Using a mold for a concrete block that has a base formed from a metallic material, the base having a ridge configured to form a notch at a top of a cast block, a body formed from a metallic material and configured to be placed on top of the base, a shoe formed from a metallic material and configured to receive one or more adjustable inserts, wherein the one or more adjustable inserts are configured to interlock with the shoe, wherein the one or more adjustable inserts are configured to interlock with the shoe using a mechanical interlock device, wherein the one or more adjustable inserts are configured to interlock with the shoe using one or more screws, wherein the body is configured to receive one or more adjustable inserts, wherein the body is configured to receive one or more adjustable inserts that are each configured to interface with an associated ridge, wherein the body is configured to receive one of a first insert or second insert, wherein the body is configured to receive one of a first insert that is configured to interface with a first ridge or second insert that is configured to interface with a second ridge, wherein the first ridge is in a different location from the second ridge, wherein each of the adjustable inserts is associated with an angle of incline, wherein a first adjustable insert is associated with a first angle of incline, wherein a first adjustable insert is associated with a first angle of incline and a second adjustable insert is associated with a second angle of incline, wherein a first adjustable insert is associated with a first angle of incline and a second adjustable insert is associated with a second angle of incline that is different from the first angle of incline, performing a method, comprising:
placing a base formed from a metallic material on surface, the base having a ridge configured to form a notch at a top of a cast block;
placing a body formed from a metallic material on top of the base;
placing a shoe formed from a metallic material and configured to receive one or more adjustable inserts in the body;
interlocking one or more adjustable inserts with the shoe;
interlocking one or more adjustable inserts with the shoe using a mechanical interlock device;
interlocking one or more adjustable inserts with the shoe using one or more screws;
placing one or more adjustable inserts in the body; and
wherein each of the adjustable inserts is associated with an angle of incline.
